(19) United States
(12) Patent Application Publication
(10) Pub. No.: US 2007/0192111 A1
(43) Pub. Date: Aug. 16, 2007

(54) Peer-to-peer network method and system for shipment delivery transactions

(76) Inventor: Matthew D. Chasen, Austin, TX (US)

Correspondence Address: HULSEY IP INTELLECTUAL PROPERTY LAWYERS, P.C., 1250 S. CAPITAL OF TEXAS HIGHWAY, BUILDING THREE, SUITE 610, AUSTIN, TX, 78746, US

(21) Appl. No.: 10/939,976

(22) Filed: Sep. 13, 2004

Related U.S. Application Data
(60) Provisional application No. 60/502,365, filed on Sep. 12, 2003.
(60) Provisional application No. 60/502,369, filed on Sep. 12, 2003.

(51) Int. Cl. G06Q 99/00

(52) U.S. Cl. 705/1

(57) ABSTRACT

A method and system facilitate peer-to-peer delivery of shipments external of traditional shipping industry channels by listing at least one non-commercial shipment in a non-commercial shipment data set using a shipment listing template. The shipment listing template permits direct listing of the non-commercial shipment by an individual user for delivering the non-commercial shipment to a predetermined destination. Listing at least one non-commercial trip in a non-commercial trip data set through a trip listing template according to a predetermined set of parameters permits direct listing of the non-commercial trip by a non-commercial traveler. Determining a necessary route deviation from the non-commercial trip for delivering the non-commercial shipment to the predetermined destination uses a set of route deviation instructions. Associating the non-commercial shipment data set with the non-commercial trip data set uses a set of matching instructions. The matching instructions facilitate an optimal matching of the non-commercial shipments to one of the non-commercial trips. The matching instructions associate further with the route deviation instructions. The method and system further facilitate a transaction between the individual user and the non-commercial traveler using a set transaction instructions.

This application claims priority from and incorporates by reference the following patent applications: U.S. Patent Applications Nos. 60/502,365 and 60/502,369 both filed on Sep. 12, 2003.

### FIELD OF THE INVENTION

The present invention relates in general to delivery systems and, in particular, to an improved package or shipment delivery system, and, even more particularly to peer-to-peer network method and system for shipment delivery transactions.

### BACKGROUND OF THE INVENTION

The United States has the most efficient commercial package delivery systems in the world. Served by companies like FedEx, UPS, Airborne Express, and the United States Postal Service, the industry does a terrific job of inexpensively handling small, ground service packages except for the instance of freight class shipments.

The business models of commercial package delivery companies dictate the maximum size of packages that can be profitably delivered using standard ground services. When packages exceed the industry standard cutoff for size and weight, even by as much as an inch or a pound, the only shipment method offered by the major carriers is ground freight or air freight, which increases costs by a minimum of 400% compared to ground shipments of the same weight. There is no cost effective way to ship freight class shipments.

One of the significant problems in the cost-effective shipment of freight class shipments concerns the load matching systems currently employed. From the carrier perspective, the objective of any search done by a load matching system is to narrow down the entire database of shipments to those that the carrier might consider transporting.

Shippers, similarly, use load matching systems to search for relevant carriers who may be interested in transporting their load. Examples of commercial load matching systems in operation as of the date of this application are Transcore Exchange, Getloaded.com, and Truckstop.com. Load matching systems consist of a database of trip or vehicle listings submitted by carriers and a database of load listings submitted by shippers.

Specifically, currently load matching systems perform the following search types: (1) radius searches for shipments that originate within a certain straight line distance from their starting location; (2) radius searches for shipments the terminate a certain straight line distance from their ending location; (3) city-to-city; (4) state-to-state; (5) state to multi-state, and multi-state to state; and (6) multi-state to multi-state.

Radius, state and multi-state searches require a carrier to perform multiple searches, choosing a large number of pairs of origination and destination locations that are possible along his route. For example, a carrier with a planned trip from Los Angeles to New Orleans might first search for shipments originating within 100 miles of Los Angeles and terminating within 100 miles of New Orleans. There are likely to be very few, if any, loads that match his exact starting and ending cities. The carrier might then search for loads originating anywhere in California with destinations in all of Louisiana. The carrier might additionally search for shipments originating in California and terminating in Arizona, New Mexico, Texas or Louisiana. The carrier may then search for shipments originating in California, Arizona, New Mexico, or Texas and terminating in Louisiana. The carrier can perform a multi-state to multi-state search for all of the states that he is driving through, but the result will contain an excessive number of irrelevant loads—many of which are going the opposite direction relative to his route. Finally, the carrier can look up cities that are on his route and “guess” which pairs of cities might have loads originating and terminating in them. There are an infinite number of load origination and destination locations along the carrier's route. As a result, current search technology is extremely inefficient at finding relevant shipments.

In light of the above, there is a need for a method and system that facilitates the cost-effective, convenient, and transportation and delivery of freight class shipments.

There is a further need for a method and system that provides an efficient way to find relevant shipments for a carrier to consider transporting.

### SUMMARY OF THE METHOD AND SYSTEM

In accordance with the invention, a peer-to-peer network method and system for shipment delivery transactions is disclosed that avoids or substantially eliminates the above-mentioned problems associated with prior methods of load matching methods and systems. The present invention provides a method and system that facilitates the cost-effective, convenient, and transportation and delivery of freight class shipments. Moreover, the present invention further provides a method and system encompassing efficient searching and selection of relevant shipments for a carrier to consider transporting.

According to one aspect of the invention, there is provided a method and system for facilitating peer-to-peer shipment of goods. The present invention includes the steps of and instructions for listing a shipment of at least one item in a shipment data set through a shipment listing template according to a predetermined set of parameters, the shipment listing template permitting direct listing of the shipment by an individual, non-commercial user for delivering the non-commercial shipment to a predetermined destination. The present invention further involves listing at least one non-commercial trip in a non-commercial trip data set through a trip listing template according to a predetermined set of parameters, the trip listing template permitting direct listing of the non-commercial trip by a non-commercial traveler. A necessary route deviation determination occurs from the non-commercial trip for delivering the non-commercial shipment to the predetermined destination using a set of route deviation instructions. The invention further involves associating the non-commercial shipment data set with the non-commercial trip data set using a set of matching instructions, the matching instructions for facilitating an optimal matching of the at least one non-commercial shipments to one of the at least one non-commercial trips, the matching instructions associating further with the route deviation instructions. The present method and system then facilitates a transaction between the individual user and the non-commercial traveler using a set transaction instructions for delivering the non-commercial shipment to the predetermined destination consistent with the optimal matching from the matching instructions.

The present invention further includes a method and system for performing a route deviation search. The route deviation search involves storing a trip listing of a carrier into a trip listing data set, the trip listing comprising a starting location and an ending location. The present invention provides for calculating a baseline parameter associated with a baseline route between the starting location and the ending location. Then, the search involves storing a plurality of shipment listings in a shipment listing data set, each of the plurality of shipment listings representing a shipment from a pick-up location to a delivery location and comprising an associated shipment pick-up location and an associated shipment delivery location. Calculating a first set of carrier parameters from the starting location to each of the associated shipment pick-up locations, as well as a plurality of shipment transportation parameters from the associated shipment pick-up locations to associated shipment delivery locations then occurs. The process further involves calculating a second set of carrier parameters from the associated shipment delivery locations to the ending location, and calculating a set of total modified route parameters comprising a total route from the starting location through each of the associated shipment pick-up locations and the associated shipment delivery locations to the ending location. The process then subtracts from each of the set of total modified route parameters the baseline parameter for all shipment listings in the shipment listing data set for yielding a route deviation for all shipments in the shipment listing data set. Finally, the route deviation search process presents to the carrier a list of shipments and associated route deviations, the list of shipments from which the carrier may select a shipment for delivering at least one of the shipments from the set of shipment listings.

The invention, therefore, provides a search process by which a trip listing that is submitted into a load matching system by a carrier is efficiently matched with shipment listings saved in the system based on the route deviation required of the carrier to transport the shipment compared to his baseline trip. Conversely, the route deviation search process also efficiently matches shipment listings that are submitted into the system with trip listings of carrier entities saved in the system.

In order to show the carrier only those loads that are most relevant to his trip, the novel route deviation search process and system of the present invention provide a list of shipments sorted, for example, by the “out-of-way” distance (or the corresponding travel time), or route deviation, for the carrier relative to his baseline trip. Conversely, a shipper using a load matching system wishes to search for only those trip listings that match the route of the shipment.

Other objects, features and advantages of the invention will be apparent from the following specification taken in conjunction with the following drawings.

### BRIEF DESCRIPTION OF THE DRAWINGS

For a more complete understanding of the present peer-to-peer network method and system for shipment delivery transactions, reference is now made to the following description which is to be taken in conjunction with the accompanying drawings and in which like reference numbers indicate like features and further wherein:

FIG. 1 shows a suitable computing environment in which the invention may be implemented;

FIGS. 2 through 7 illustrate aspects of operating the system and method of the present invention.

FIG. 8 shows the process flow for the registration process of the present invention;

FIGS. 9 through 12 depict a first step in the registration process;

FIG. 13 depicts the shipper process flow chart of the present embodiment;

FIG. 14 shows the driver process flow chart of the present embodiment;

FIGS. 15 through 25 show the various fields provided by the present invention for processes and functions in implementing a peer-to-peer delivery system.

FIG. 26 shows a map of the US highway system.which includes the starting and ending locations; and

FIG. 27 portrays the search process of the present invention from both the carrier and shipper perspectives.

### DETAILED DESCRIPTION OF THE ILLUSTRATIVE EMBODIMENTS

Preferred embodiments of this invention are described herein, including the best mode known to the inventor for carrying out the invention. Variations of those preferred embodiments may become apparent to those of ordinary skill in the art upon reading the following description. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

The inventor expects skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The embodiments of the present invention may comprise one or more special purpose or general purpose computers including various computer hardware devices, as discussed in greater detail below. As used herein, a “memory,” “recording medium,” and “data store” may be any means that contains, stores, communicates, propagates, or transports the program and/or data for use by or in conjunction with an instruction execution system, apparatus or device. For example, memory, recording medium and data store may be, but are not limited to, an electronic, magnetic, optical, electromagnetic, infrared or semiconductor system, apparatus or device. Memory, recording medium and data store may also include, but are not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that several of the acts and operation described hereinafter may also be implemented in hardware.

Embodiments within the scope of the present invention also include computer-readable media for carrying or having computer-executable instructions or data structures stored thereon. Such computer-readable media may be any available media which may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which may be used to carry or store desired program code means in the form of computer-executable instructions or data structures and which may be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

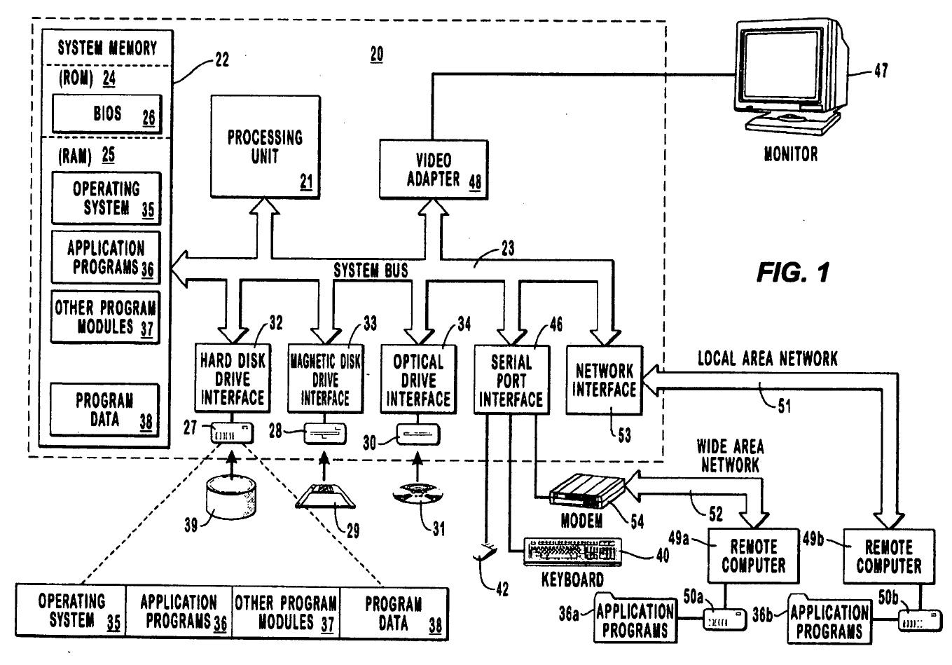

FIG. 1 and the following associated description intend to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc., that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 3Q for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data may be used, including magnetic cassettes, flash memory cards, digital video disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more software application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated software application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

The present invention provides a completely open, Internet-based system and method for matching any type of shipment with any type of entity willing and able to delivery that shipment. This open system efficiently matches shipments with vehicles traveling along the route of the shipment with excess capacity. This system and method can operate outside of the conventional shipping industry by allowing individuals to tap into this excess capacity and achieve savings of up to 80% on their shipments compared to commercial rates. The savings is achieved by matching shipments with drivers, which may include individuals, who are traveling along the route of the shipment and can often deliver shipments at significantly lower price points than commercial carriers. The present system gives private or non-commercial drivers, i.e., the traveling public, the opportunity to subsidize their transportation expenses by picking-up and delivering shipments on the way to their destination.

The following terms are used within this description of the present embodiment for the purpose of illustrating the novel features and functions of the present invention. Although the terms and definitions herein provided are helpful, the present invention is not necessarily limited to the terms and definitions herein provided. Accordingly, as used herein, a carrier is an entity that intends to take a trip in a particular vehicle and wishes to utilize excess capacity in his vehicle by transporting goods for compensation from a shipper. Carriers can be commercial truck drivers, freight couriers, package delivery couriers, individuals, etc. A shipper is an entity that has a load that he wishes to have transported from one location to another by a carrier for compensation. Shippers can be freight consolidators, freight forwarders, package delivery companies, businesses, individuals, etc. A trip listing may consist of the following data fields: Starting address or location, starting date and time, ending address or location, ending date and time, return trip date and time (if any), vehicle type (or make/model), carrier contact information, equipment type, etc.

A shipment listing may consist of the following data fields: title, description, length, width, height, weight, origination address or location, location type (residence or business), availability date, sender name, sender contact information, destination address or location, location type, recipient name, recipient contact information, packaging type, special equipment required, acceptable vehicle types, etc. A load matching system is an information system that collects trip (or vehicle) listings from carriers and load listings from shippers. These systems are used by carriers to find loads to fill excess capacity in their vehicles, and by shippers to find available carriers. A load is an item or a collection of goods that a shipper wishes to transport from one location to another. A load can be a full commercial truckload, less-than-truckload (LTL) freight, consolidated freight, a single item, etc.

Novel aspects of the present invention include the ability to permit private drivers to participate in the shipping marketplace. However, the present invention's open system is not limited to individuals and can be use by commercial carriers (e.g., household movers, freight brokers, freight carriers, etc.). This open system is far more cost effective for shipping freight class shipments than the traditional freight industry. Recognizing that interstate highway traffic includes thousands of pick-up trucks, vans, station wagons, SUVs, and box trucks driving between cities. The vast majority of these Light Duty Trucks (LDTs) have empty cargo space, and each empty SUV represents up to 144 cubic feet of excess capacity. Accordingly, drivers may use the present system to defray their transportation expenses through compensation offered by shippers for delivery.

The present invention also differs from existing freight matching systems in several key ways. For example, the present system allows new entities, including individuals and private drivers, to participate in the shipping market. Therefore, the present method and system operate partially outside the traditional shipping industry. With the present invention, shippers (end users) can list shipments directly rather than going through freight brokers (middlemen). Moreover, shipments are not limited to consolidated, palletized freight; therefore anything from an unpackaged, individual item to a household move to a commercial freight load can be listed and matched. Shippers can list their own offer price for their shipment and be matched with carriers willing to deliver their shipment for their specified price. Also, shippers can list their shipments and receive binding counter-offers from carriers who can deliver the shipment for lower costs because they have excess capacity on trip they are taking.

In current commercial freight consolidation systems, palletized freight, less-than-truckload freight, or truckload freight is posted on bulletin-board-like systems, and professional rig-drivers search for loads to fill their excess capacity. The present system allows individual end consumers to post individual items that they would like shipped outside the normal commercial channels. By bypassing the commercial shipping industry and freight broker middlemen, shippers are able to transport their goods and save up to 80% in the process.

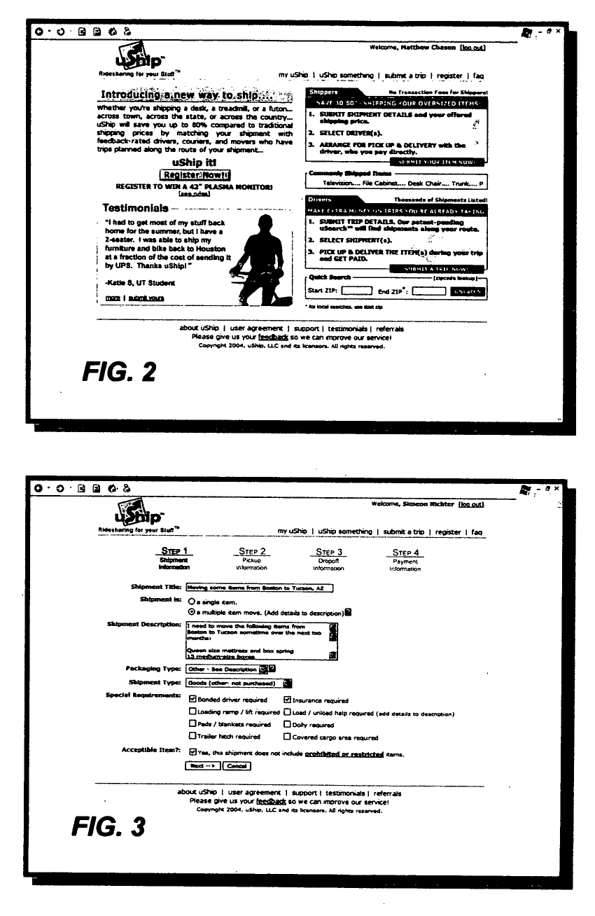

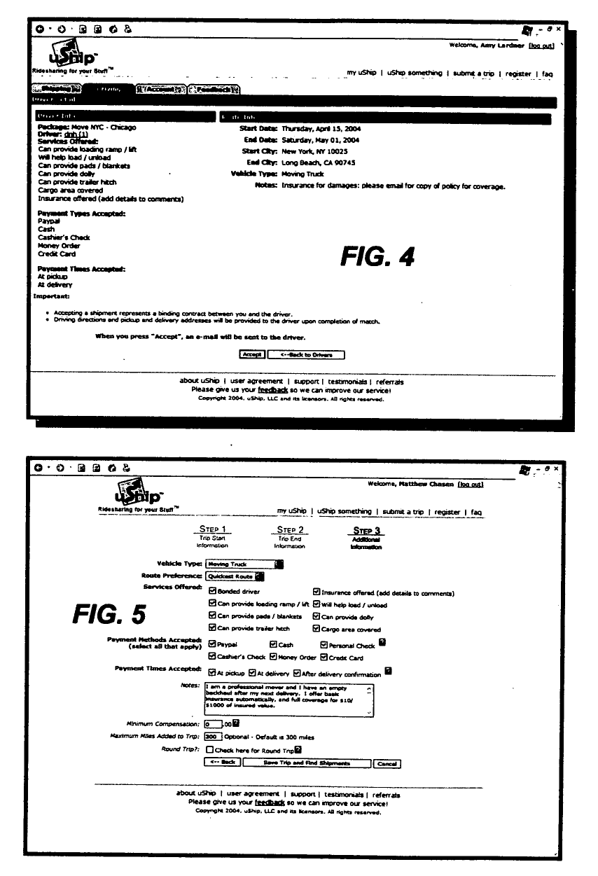

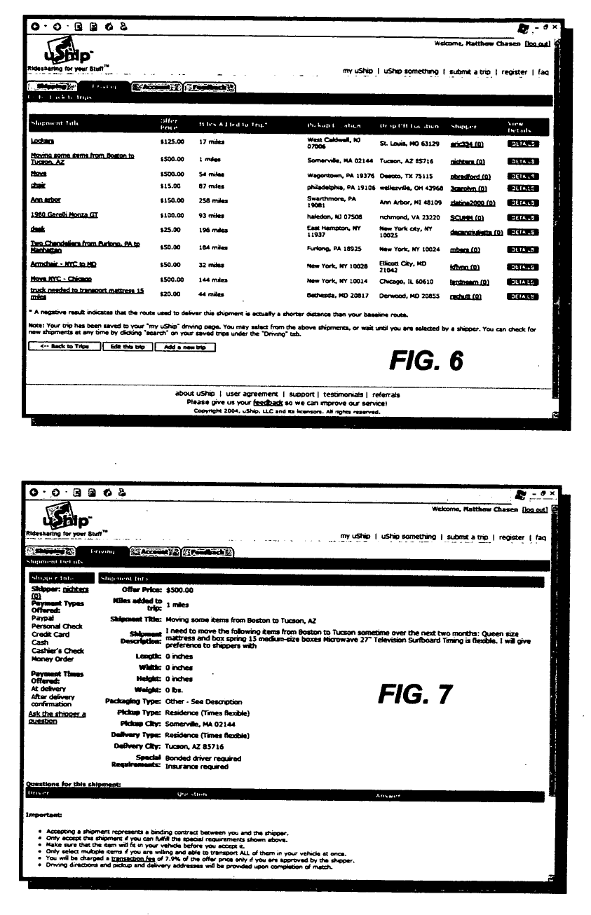

FIGS. 2 through 7 illustrate aspects of operating the system and method of the present invention. Beginning with FIGS. 2 and 3, it is seen that the present system includes a website where shippers list their shipments details including but not limited to origination address, destination address, size, and weight. Similarly, as FIG. 2, 4, and 5 show, drivers may submit their trip details. FIG. 6 shows that search technology described and claimed herein sorts shipments by “route-deviation”, offered compensation, and shipper feedback. FIG. 7 reveals that after the driver chooses a shipment and is approved by the shipper, the driver is e-mailed custom driving directions for his trip. Shippers pay drivers directly during pick-up, during drop-off, or after the delivery is complete. Through the system of the present invention, the driver pays a transaction fee at the time when the match is made.

With the general overview of FIGS. 2 through 7, the present invention further includes specific implementation aspects. As such, in the preferred embodiment, a shipper may review quotes from traditional commercial carriers and can contract with these carriers if desired, submit the price they are willing to pay to have their item transported using the peer-to-peer marketplace, list their shipment without an offer price to receive binding counter-offers from carriers in the marketplace. A shipment listing may consist of the following data fields: title, description, length, width, height, weight, packaging type, special equipment required for transport, acceptable vehicle types, origination address or location, location type (residence or business), availability date, sender name, sender contact information, whether or not the carrier is required to assist in loading, whether or not the shipment will be left at a specified location for self pick-up by the carrier, delivery address or location, location type (residence or business), recipient name, recipient contact information, whether or not the carrier can leave the shipment at a specified location without interaction with the recipient, shipping offer price, and forms/methods of payment offered to carrier.

After listing a shipment, the shipper may be shown a list of our member-trips that are along the route of their shipment, along with the members' trip dates and feedback ratings. This list is generated by the “route-deviation” search process. Shippers may also browse for carriers by selecting the starting and/or ending state for trip listings. Shippers may either choose a driver immediately, if they find one that meets their criteria, or they can save the shipment on our system to be notified when a qualified driver is available. A selected driver is sent an e-mail notifying them of the shipment. The driver then reviews the shipment details and accepts declines or makes a counter-offer on the shipment. If more than one carrier is selected, the first to accept will create a match. The shipper is sent an email notifying them of each carrier's acceptance, decline, or counter offer. If all of the carriers selected decline, the shipper can return to the system to perform another search and select additional drivers.

A trip listing may consist of the following data fields (details): Starting address or location, starting date and time, ending address or location, ending date and time, return trip date and time (if any), vehicle type (or make/model), carrier contact information, carrier's willingness to assist in the loading/unloading of a shipment into/from his vehicle, equipment that the carrier can provide to assist in the loading/unloading or transportation of a shipment, carrier's willingness to pick-up (or delivery) a shipment at a residence and/or a business given the hours of operation at the location, the forms/methods of compensation the carrier is willing to accept, the minimum compensation that the carrier is willing to accept to transport a shipment, and the maximum deviation from the carrier's baseline trip that he is willing to go to transport a shipment.

In operating the present method and system, a user, who may have joined into a database associated with the present system, who may be planning road trips may submit their starting address, ending address, and the trip dates (including the date of return if a roundtrip). The driver may then be presented a list of items sorted by route deviation, price, size, or shipper feedback. The driver chooses one or more items to transport, or if no match is made the driver saves his trip in our system to be notified when an item is available for delivery on his planned route. The selected shipper is sent an e-mail notifying them of the driver's trip. The shipper then reviews the trip details and accepts or declines the driver's trip. The driver is sent an email notifying him of the shipper's response.

In addition to listing a trip, a drivers or carrier may also use one or more other search methods in addition to the “route deviation” search herein described. A carrier may, for example, browse shipment listings by state. With the present system, that selection of a state allows a carrier to view shipments starting in that state, ending in that state, and starting and ending within that state. A carrier may also conduct a state to state search by selecting a starting state and ending state to view shipments going from one specific state to another. Moreover, a carrier may perform a quick route deviation search in order to select a starting zip code, ending zip code, and maximum miles added to trip to view shipments along the outbound and return route.

After reciprocal approval process provided by the present invention, a match is complete and the system delivers personal contact information to each party in order to coordinate the pickup and drop-off. Concurrently, the driver's credit card is charged a transaction fee percentage of the agreed upon price. The driver is provided detailed driving directions from the starting point, to the pickup location, then to the drop-off location, and finally to his destination address.

Particularly novel aspects of the present invention include an open peer-to-peer marketplace system that enables individual, end-user shippers to list shipments directly for consideration by all driver/carriers and therefore disintermediate freight brokers and freight companies to achieve significant savings. Through the present open peer-to-peer system, any and all drivers/carriers may transact with shippers by searching or listing their trips. Moreover, the system makes use of the novel route deviation search process described herein below.

The present system provides dollars per hour, mile sorting, and other filtering processes. Only those shipments for which the compensation is high relative to the distance or time required for pick-up and delivery will be relevant to the carrier. To assist the carrier in evaluating the compensation/distance tradeoff, the process permits calculating a familiar dollars per hour metric for relevant shipments and allow the carrier to sort and filter based on this metric. Using the cargo area sorting/filtering functions, a driver may specify his particular vehicle make and model. The system may then look up the cargo area dimensions for that vehicle and only search for packages that will fit into the vehicle. The most important element is fit, because if the carrier's vehicle is too small or not equipped to handle the shipment then it cannot be offered as a search result. The present invention's searching capability automatically looks up the cargo capacity (dimensions, weight, etc.) of the carrier's vehicle (in a table) and eliminates from consideration those shipments that exceed any one limitation on the vehicle's capacity. This represents an improvement over known systems which sort based on type of truck (flatbed, etc.) not on cargo volume/weight.

The present invention also provides weight requirement sorting/filtering, since, heavier shipment listings may automatically require for necessary equipment (liftgate, dolly, etc.) for matching trip listings. Using the present system's weather consideration sorting/filtering functions, a shipper may include in their shipment listing the requirement that the carrier vehicle be covered so as to not be exposed to the weather during transport. According, the system may automatically filter out uncovered transportation options.

Another aspect of the present invention includes a set of security of personal information features. With the present invention, member addresses and contact information are not divulged to counterparties until the mutual acceptance process is complete (shipper reviews driver feedback and approves them). Moreover, there is provided a return trip search function, such that if a carrier selects “return trip,” when using the system, a return trip listing is automatically generated, saved, and run to show the carrier shipments along the return route, as well as on specific dates for the return trip delivery.

The present invention provides a robust set of route deviation search filtering/sorting functions, as herein described. The search results for a carrier may be filtered and sorted by route deviation and automatic cut-offs can be implemented for at parameter predefined by the carrier (maximum miles added to trip=300 miles, e.g.).

Further novel aspects of the present method and system include indefinite trip listings, by which a carrier may save a trip listing with no trip dates and be notified when anything along this route is listed that meets the above criteria. The system will save the trip indefinitely, i.e., with no trip dates. A minimum offer price filtering/sorting function permits a carrier to choose a minimum compensation that is required to pick-up and drop-off any shipments during the shipper's trip. All search result can be sorted and filtered by minimum offer price. A binding counter-offer function provides an alternate to accepting the price set by the shipper, carriers may chose to make a binding counter offer that will be sent to the shipper. The binding counter offer will last for a duration specified by the carrier and will expire thereafter or after the start date of the trip.

The present system also provides carrier driving directions so that when a carrier matches with a shipment, the carrier automatically receives a new route and driving directions for the trip. The driver then will have a different trip saved with multiple stopovers and can perform route deviation searches along this new route.

A reciprocal approval process occurs after a member accepts a matching trip or shipment, the counterparty is able to review that member's feedback and listing details and decide to accept, decline, or make a binding counter offer for the listing. Accepted shipment and trip listings are visible in the “matches pending” table on the system. A multiple carrier selection addresses the situation of more than one carrier being selected by the shipper, in which case, the first to accept in return will create a match. Using a saved searches function, a carriers can save any type of search they run on the system and the system will notify the carrier (via email, phone, fax, mobile alert, etc.) when new shipments are listed that meet their search criteria. Moreover, a trip listing expiration function sets trip listings to expire after duration specified by the carrier or after the trip start date, and a shipment listing expiration function permits shippers to choose to include a listing expiration date for their shipment listing, after which time the shipment will be removed from our active shipments database. Shippers may also choose to list their shipments indefinitely. Still further, shipment listing expiration sorting/filtering functions permit a carriers to choose to sort or filter their search results by date of shipment listing expiration. A carrier acceptance expiration function optionally sets carriers' acceptances of shipments to expire after a duration specified by carrier or after the trip start date.

The present method and system provides an offered pick-up and delivery dates function, such that when a carrier accepts a shipment, the carrier may can choose to submit offered pick-up and delivery dates which will then be automatically included in their trip listing visible to the shipper. In addition, offered pick-up and delivery date sorting/filtering functions apply so that when a carrier accepts a shipment, the carrier can choose to submit offered pick-up and delivery dates which will then be automatically included in their trip listing visible to the shipper. The shipper may then sort or filter their matched trip listing by offered pick-up and/or offered delivery date.

The present method and system provide a function for questions and answers for shipment and trip listings. Because direct contact information is withheld until a match is complete, a question and answer system allows shippers and drivers to communicate via their shipment/trip listing pages. Members may ask questions directly from the listing page and the listing member is sent an email notifying them of the question. When the listing member responds to the question, the member who asked the question receives and email notifying them of the answer.

The “Shipments/Trips I'm Watching” tables allow carriers and shippers to save listings for easy retrieval without running the searches again. The carriers and shippers can return to the listing to ask questions, view other questions and answers, and accept the listings. Through a “Ship Now” option, a shipper can choose to include a “Ship Now” offer price for their shipment listing. This is a binding offer price that may bypass the driver approval process. Drivers that accept “Ship Now” shipments may be required to have a minimum feedback rating. A driver approval bypass permits a shipper to choose to automatically accept any driver that accepts their item. The shipper can further choose to automatically approve any driver that has a minimum feedback rating specified by the shipper.

A shipment listing photographs function permits a shipper to upload a digital photo of their shipment to assist the carrier in deciding whether or not to accept a shipment. Moreover, a shipment listing photograph sorting/filtering function allows a carriers to choose to sort or filter search results by availability of shipment photographs. Trip listing/carrier profile photographs permit a carrier to upload a digital photo of their vehicle to assist the shipper in deciding whether or not to accept the carrier. A trip listing photograph sorting/filtering function allows a shippers to choose to sort or filter their search results by availability of carrier photographs.

A browse/search completed shipments function permits any member to choose to browse through our database of completed shipment transactions. This will allow shippers and carriers to determine the likelihood that a shipment has of being accepted at different price points. Members can also search completed shipments by keyword. Shipment and trip listings may be searched by keyword. For example, if a carrier specializes in transporting motorcycles, then that carrier can search for shipment listings containing the word “motorcycle”. Shippers and Carriers can chose to have their listing included in a table of “Featured Shipments/Trips”, which will be placed in a high-traffic area of the website (homepage, e.g.). This will give the listing more exposure in the marketplace and increase the likelihood of a match. Carriers may also specify the route to use as their baseline route for route deviation calculations. Carriers may specify a route by automatically choosing the shortest route, the fastest route, or a route through any number of intermediate stop-over locations.

The present method and system also provide a special requirements sorting/filtering function by which search results may be sorted or filtered by the shipment or trip listing containing any of the aforementioned special requirements (insurance offered, bonded carrier, covered cargo area, lift gate, etc.). When a carrier views a shipment listing, the page may contain a map showing the carriers baseline route and a new route including the pick-up and delivery stops, allowing the carrier to get a visual sense of the change to their planned trip. If no trip was submitted, the map may show only the pick-up and delivery route. Similar maps may be shown on trip listing pages showing shippers the exact route of the carriers trip. Moreover, a carrier may sort or filter their search results by the shipment type (Goods Purchased—Auction, Goods Purchased (non-auction), Goods—not purchased, household move, LTL (Less-than-truckload) freight, TL (truckload freight), Refer (Refrigerated) load, commercial move, etc.).

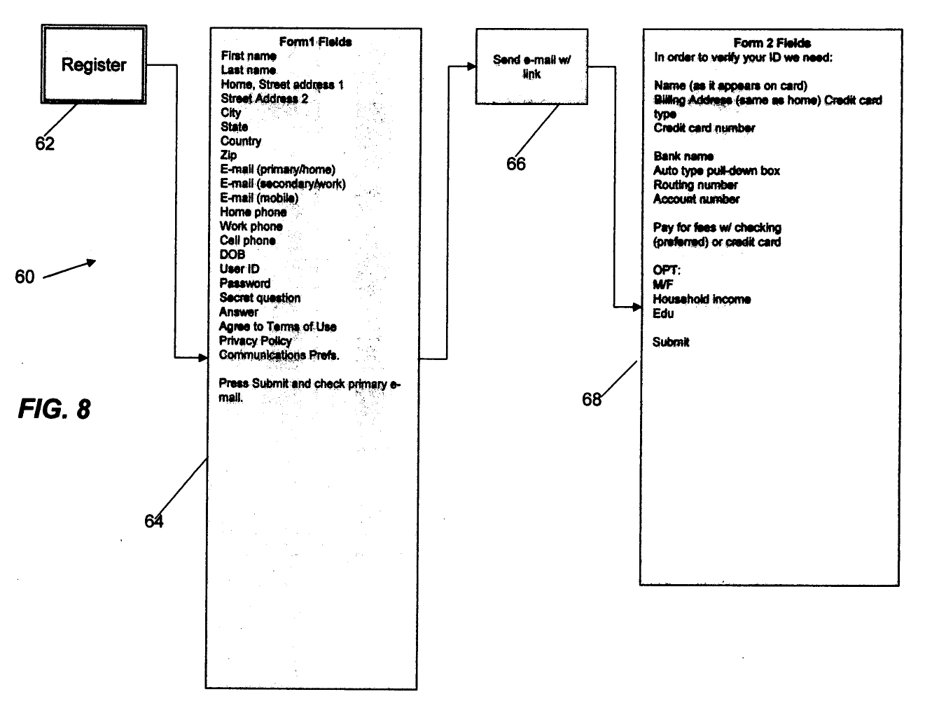

FIG. 8 shows the process flow for the registration process 60 of the present invention. In order to list an item for shipping or submit a trip, users must complete the registration process. There is a link to the login/registration page 62 from the home page present shipping process. The login/registration page 62 has an area for current members, whereby members may submit their username and password, and check a box to “Keep me signed in until I logout”. Process flow 60 proceeds from login/registration page 62 to Form 1 Fields 64. After completing Form 2 Fields 64, process flow proceeds to send e-mail w/link step 66. Thereafter, Form 2 Fields 68 are made available to the user. Form 2 Fields 68 request specific, confidential information about a user, as shown. After completing this information properly, the user becomes a member of the shipping system. There is also an area with a register form and “In order to provide the most trustworthy community on the internet, all users are required to register with us. Registration involves verifying the member's e-mail address and identity, for example, via a credit card. The member's credit card may also be used to pay for any fees that the member may incur.

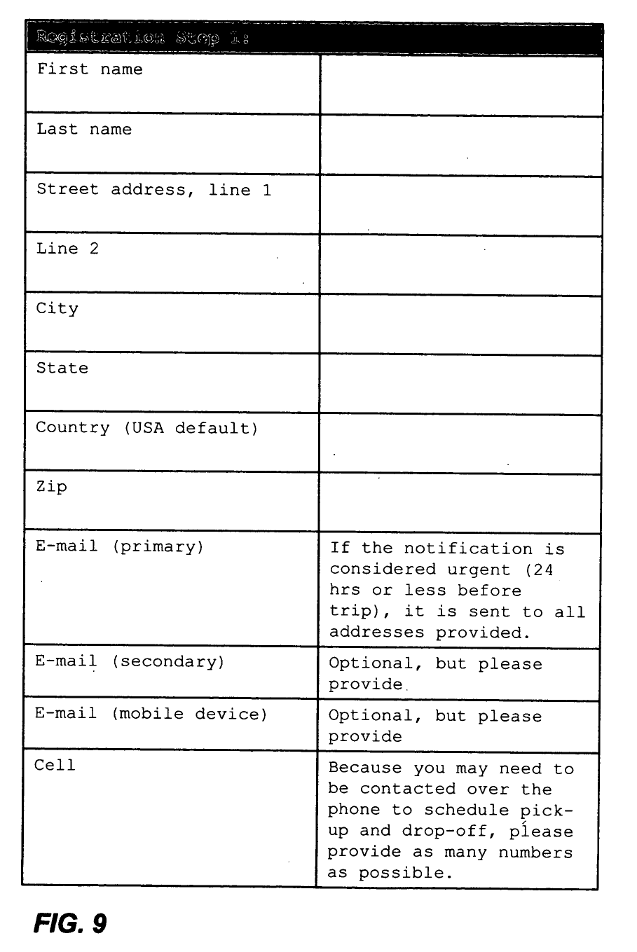

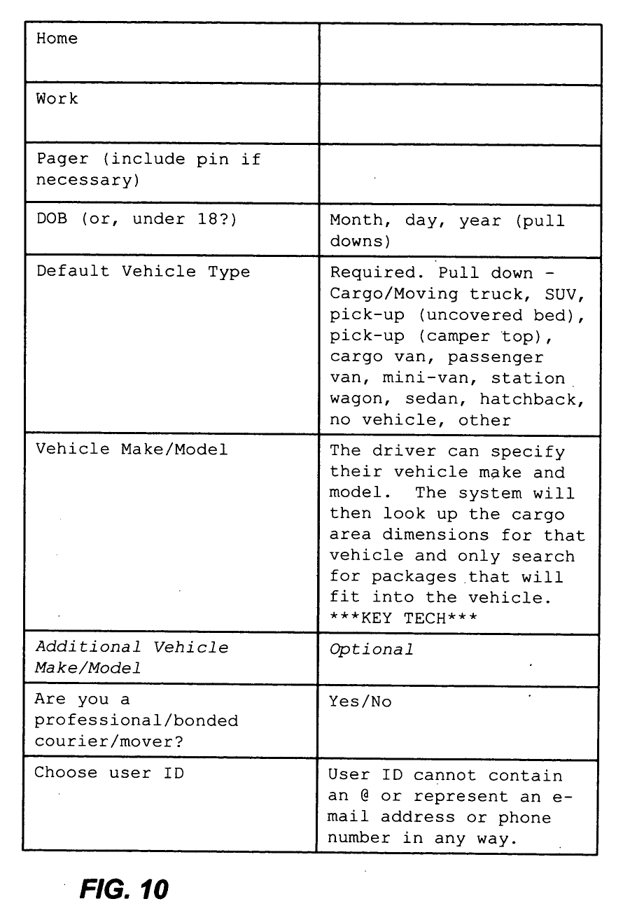

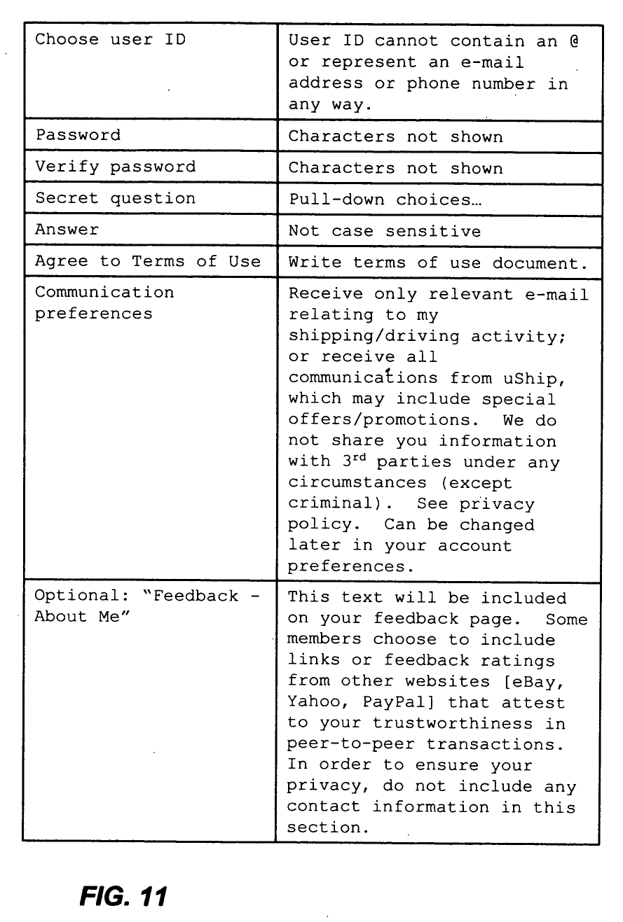

In the preferred embodiment, shippers pay no listing or transaction fee. Drivers pay a transaction fee, which is a small percentage of their compensation, only after a confirmed match is completed thereby allowing a link to fee schedule. FIGS. 9 through 12 depict the first step in the registration process, where by a user clicks on the register button and is taken to the step 1 template there provided. The present embodiment also provides a user identity check. In order to verify the user's e-mail address, an e-mail will be sent to the user's primary e-mail address when the user clicks on submit. The e-mail will contain an encrypted link that the shipper must follow to finish the registration process. For e-mail verification, an e-mail is sent to the primary address with the following subject line: uship Registration. In the body of the message, appears: “The shipper is almost finished with the registration process. Use the following link to return to our site, where the shipper will log in to complete the shipper's registration. Before the shipper's first transaction, the shipper must submit a credit card for identity verification and billing purposes.

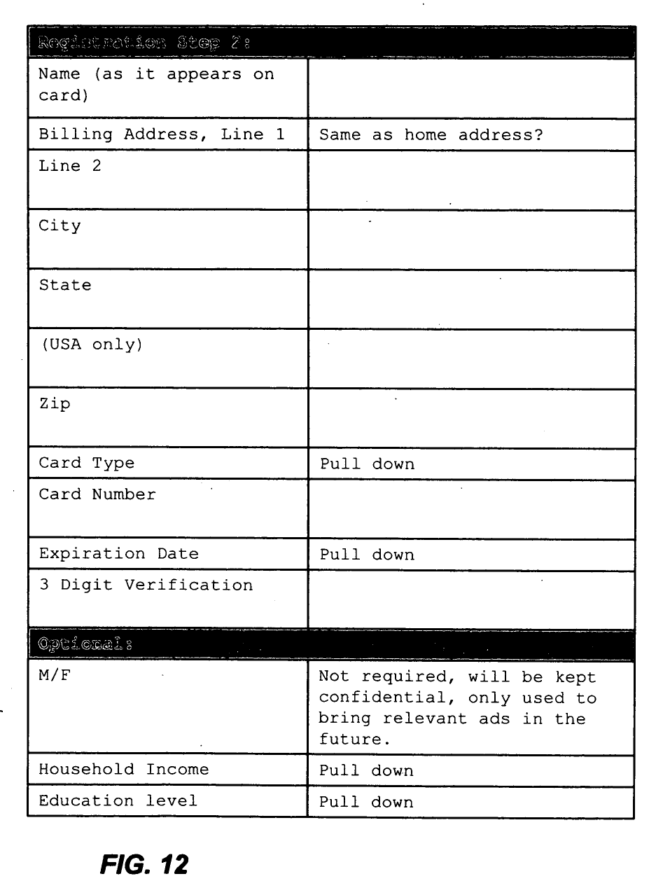

Another aspect of the present embodiment is a credit card form which a member prospect uses. The fields for the credit card form appear in FIG. 12. Following the completion of the credit card form a credit card verification process occurs.

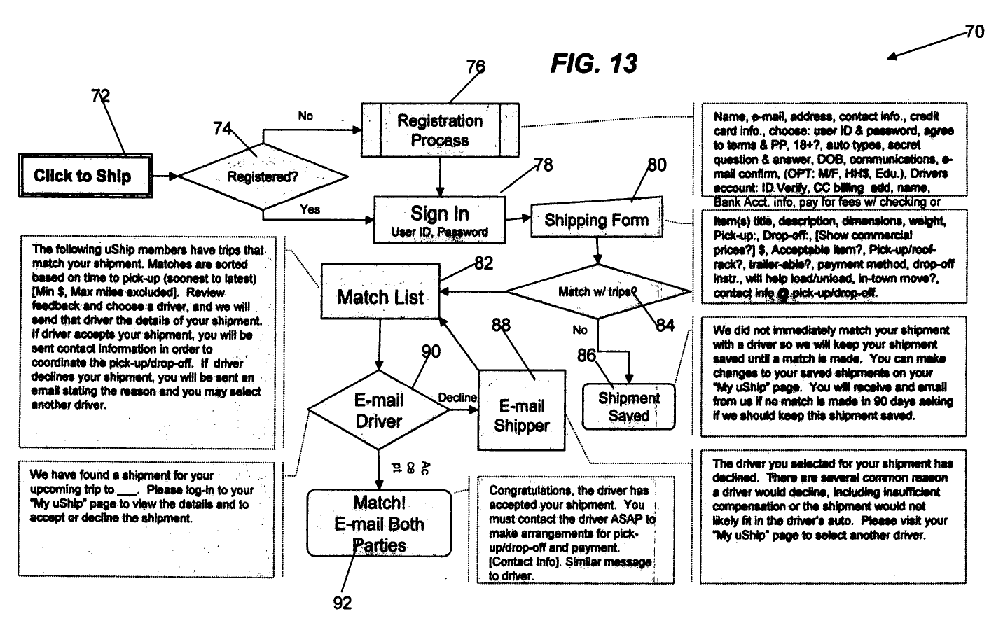

FIG. 13 depicts a simplified embodiment of the shipper process flow chart 70 of the present embodiment that the present invention may employ. In shipper process flow chart 70, a shipper begins the process by clicking the associated icon 72 on the shipping process home page. Then, process flow chart 70 goes to Registered? query 74, which tests whether the shipper is a registered member of the service. If not, then process flow 70 proceeds to step 76, at which the registration process of FIG. 8 occurs. On the other hand, if the shipper is registered or the registration process is complete, then process flow 70 goes to sign in step 78. After sign-in occurs, process flow continues to shipping form step 80. At shipping form step 78, the shipper completes the forms described below for describing a desired shipment. With a completed shipping form, process flow 70 goes to query 82, which tests whether the desired shipment matches any existing trips. If so, process flow 70 proceeds to match list step 84, at which the carriers having trips that match the desired shipment are listed on a interface that is presented to the shipper. If no trips match the desired shipment, then, the shipper is notified of that fact, and process flow goes to a shipment saved data set 86.

From match list step 84, process flow continues to query 88, at which point a driver is contacted via E-mail to determine whether the driver agrees to deliver the shipment. If the driver declines to deliver the shipment, then process flow continues to step 90, at which point the shipper is notified that the driver declined. If, on the other hand, the driver accepts, then process flow 70 proceeds to step 92, where both shipper and driver are notified and a shipping transaction proceeds, ultimately leading to the delivery of the shipment and the payment therefor.

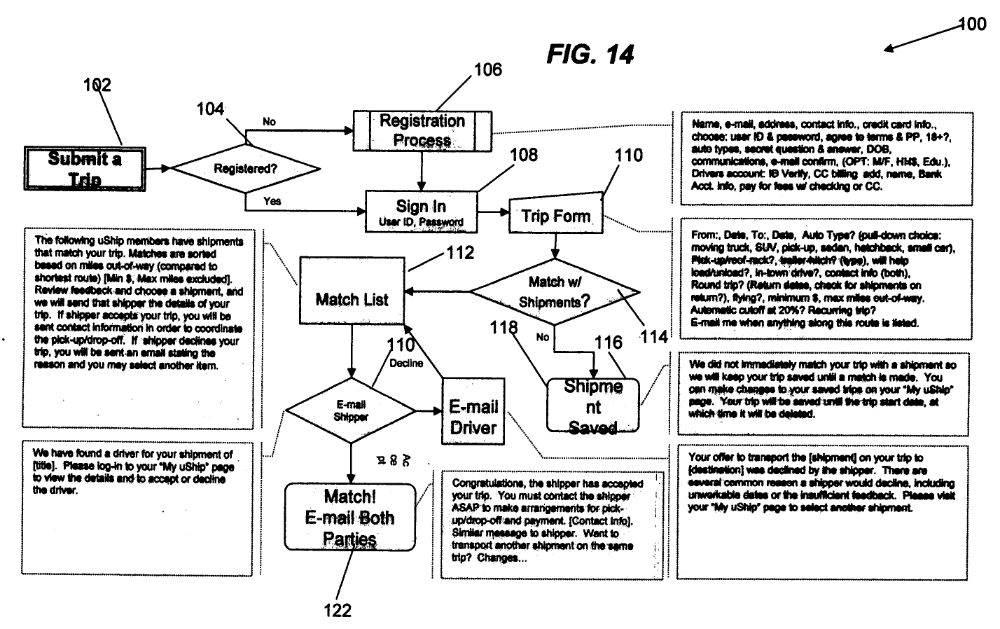

FIG. 14 shows a simplified driver process flow chart 100 that one embodiment of the present embodiment may employ. In driver process flow chart 100, a driver begins the process by clicking the associated icon 102 on the driver process home page. Then, process flow chart 100 goes to Registered? query 104, which tests whether the shipper is a registered member of the service. If not, then process flow 100 proceeds to step 106, at which the registration process of FIG. 8 occurs. On the other hand, if the driver is registered or the registration process is complete, then process flow 100 goes to sign in step 108. After sign-in occurs, process flow continues to shipping form step 110. At shipping form step 108, the driver completes the forms described below for describing a trip. With a completed driver form, process flow 100 goes to query 112, which tests whether the trip matches any existing shipments. If so, process flow 100 proceeds to match list step 114, at which the shippers having shipments that match the trip are listed on an interface that is presented to the driver. If no shipments match the trip, then, the driver is notified of that fact, and process flow goes to a trip saved data set 116.

From match list step 114, process flow continues to query 118, at which point a shipper is contacted via E-mail to determine whether the shippers agrees to have the driver deliver the shipment. If the shipper declines to have the driver deliver the shipment, then process flow continues to step 120, at which point the driver is notified that the shipper declined. If, on the other hand, the shipper accepts, then process flow 100 proceeds to step 92, where both shipper and driver are notified and a shipping transaction proceeds, ultimately leading to the delivery of the shipment and the payment therefor.

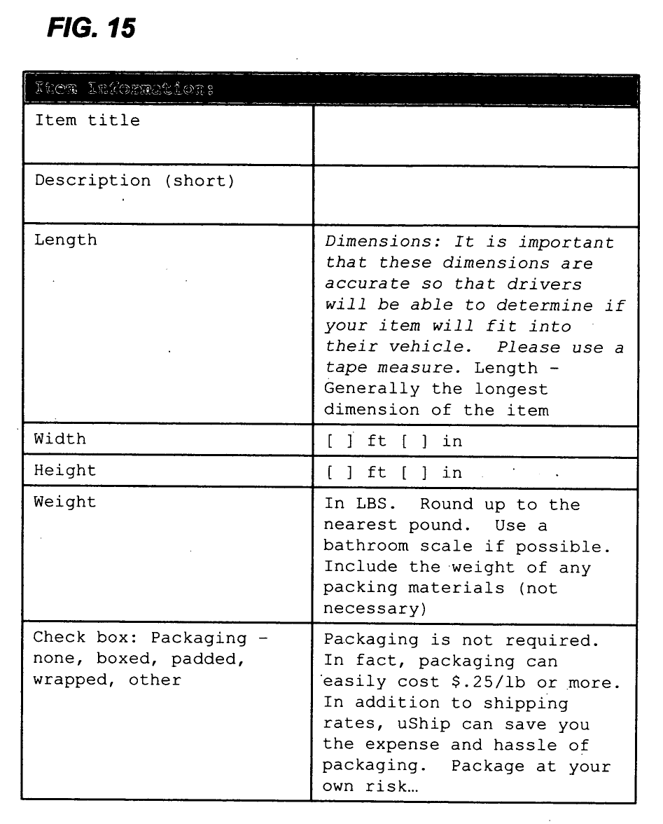

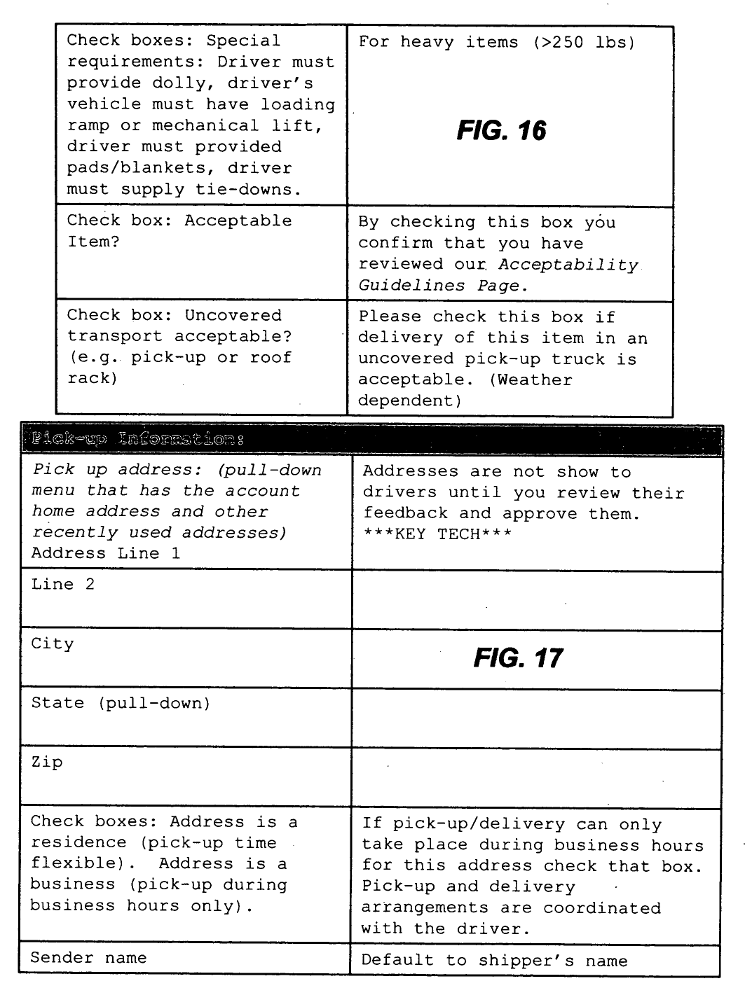

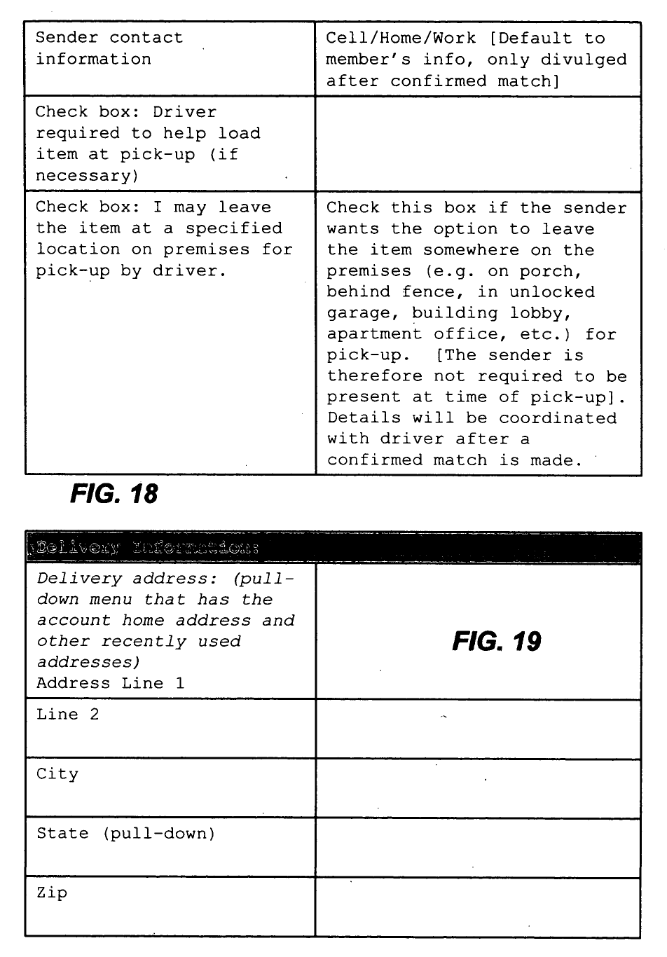

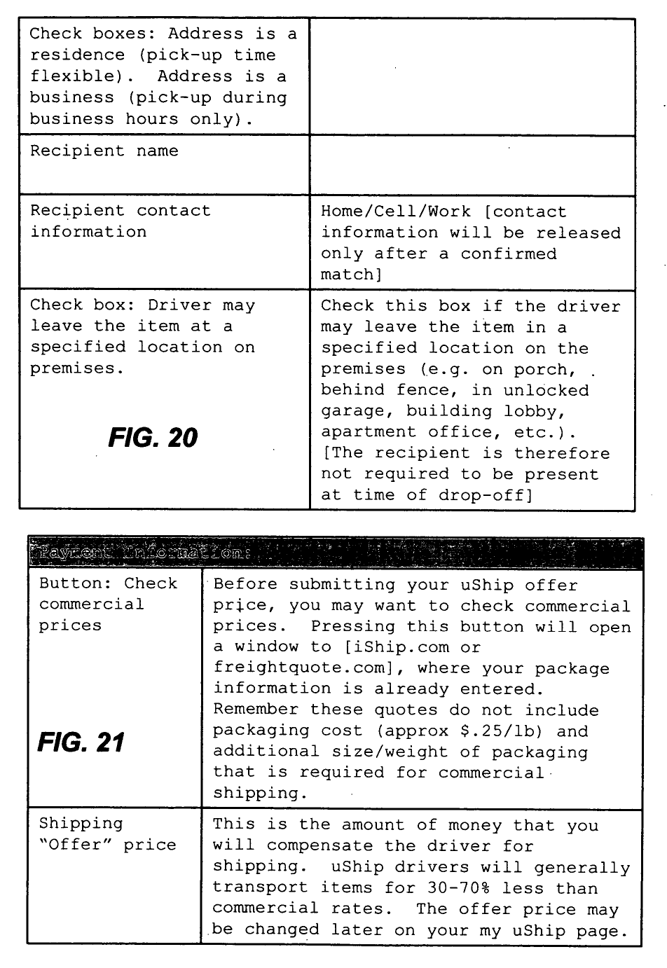

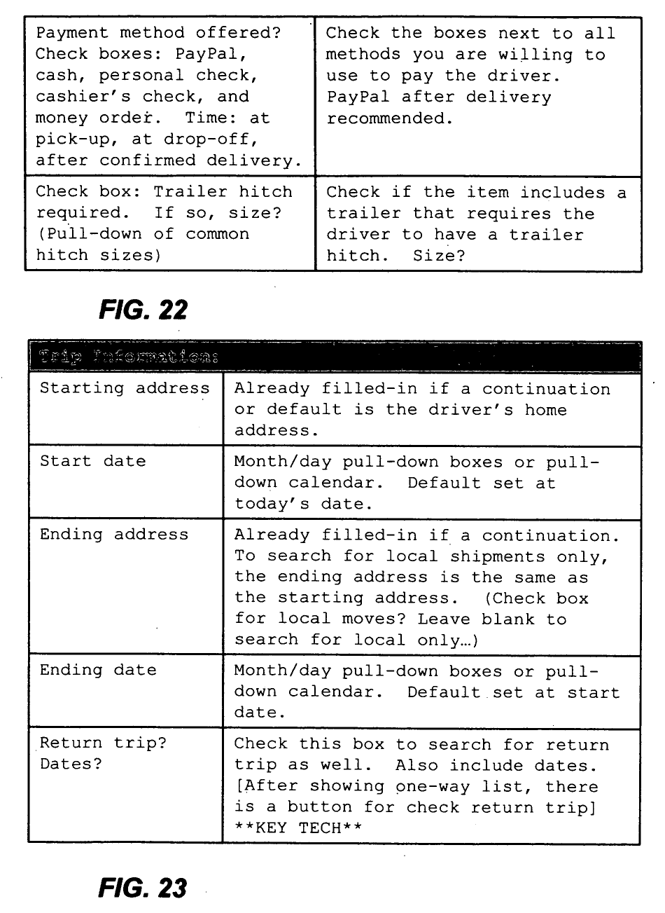

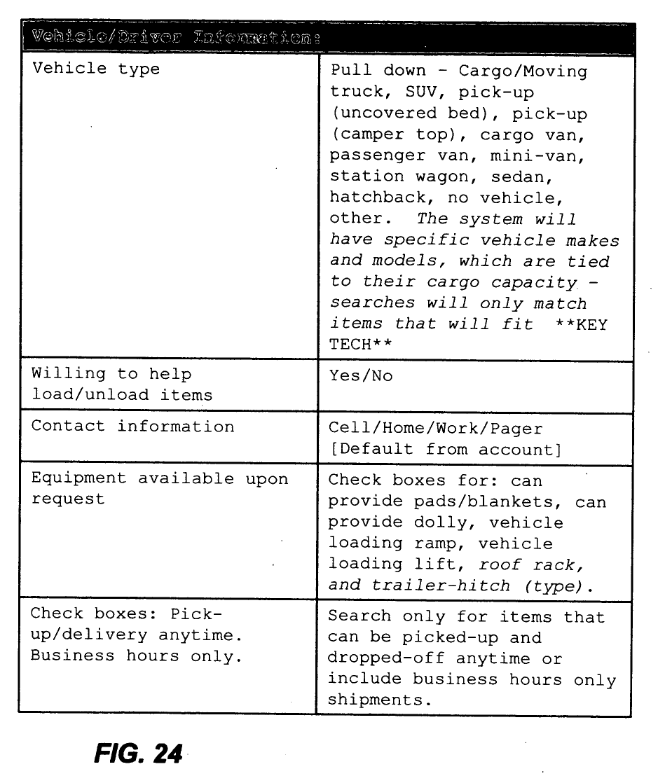

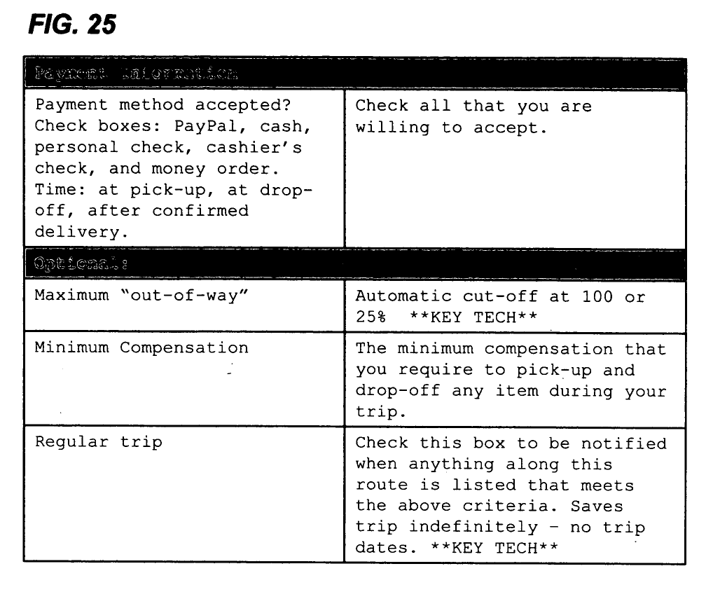

FIGS. 15 through 25 show the various fields provided by the present invention for these and related processes and functions in implementing the present method and system for enabling a peer-to-peer delivery system. From a home page, the shipper may choose to submit an item for shipping. If the member is logged in, process flow goes to the shipping form, which appears at FIG. 15. If not process flow goes to the Login/Registration page. Fields of the shipping form appear in FIGS. 15 through 22.

In using the route deviation search results, a user clicks submit and the system saves database fields and checks item against saved trip database for potential matches. Any matches are presented and can be sorted by trip date or driver feedback. Matches also show vehicle type, user ID, etc.

Each listing has a button for “Details”. On this details page, the shipper can post a question about the trip. The driver is sent an email notifying them of the question and they can post a response. Next to each match is a button: “Select this driver”. “Please select one or more drivers from the list below. Drivers will be sent an e-mail notifying them of the shipper's shipment. Drivers will review the shipper's shipment details and accept or decline the shipper's shipment. If the shipper selects more than one driver, the first to accept will create a match. The shipper will be sent an email notifying the shipper of each driver's acceptance or decline. If all of the drivers the shipper select decline, the shipper can return to the shipper's my uship page and select additional drivers.

The e-mail will include contact information of the shipper's driver for the shipper to coordinate pick-up and drop-off. Remember, the shipper's selection of a driver is a binding contract between the shipper and the accepting driver that the shipper will compensate them the specified amount.” If there are no trips saved that meet the criteria, a page reads: “We were not able to match the shipper's shipment with any drivers immediately. The shipper's shipment has been saved and the shipper will be notified when a driver selects the shipper's shipment.

The shipper will have the opportunity to review the driver's feedback and accept or decline any driver's offer to transport the shipper's item. The shipper may edit any of the shipment details on the My uship page. If the shipper decide not to ship the shipper's item, or the shipper choose to ship by another means, please delete this shipment. The shipper will be sent a reminder e-mail every week that the shipper's listing is active. If a considerable amount of time passes without any driver interest, the shipper may want to increase the shipping price.”

The driver selection process of the present invention permits a user to review information and select one or more drivers from the list. The driver(s) receives an e-mail stating, “The shipper have been selected by a shipper to deliver an item during the shipper's upcoming trip. Please log in to the shipper's my uship page [link to log-in page] to review the details and accept, decline, or submit a binding counter-offer for this item. The shipper may have selected multiple drivers, so log in as soon as possible or another driver may accept the shipment before the shipper has a chance. The shipper's trip listing will be kept active until the start date of the shipper's trip so that the shipper may be considered for additional shipments for the shipper's trip. If the shipper would not like to be considered for additional shipments, please delete the shipper's trip listing after accepting the shipper's offer.”

When each driver selected by the shipper responds, the shipper is sent an e-mail. In the event of an acceptance, the following is received:
“A driver, user ID, has accepted the shipper's shipment. Please contact this driver ASAP to coordinate the pick-up and drop-off. This driver's contact information is as follows: Home, cell, work, e-mail preferred, e-mail other. The shipper must be flexible with the driver when determining pick-up and drop-off times. The shipper may discuss the following with the driver: time/method of payment, special requirements during pick-up and drop-off (e.g. call the recipient 30 minutes prior to dropping off item at the following cell number), any issues that may arise regarding loading the shipper's item into the drivers vehicle, if the shipper would like the driver to provide a moving pad or blanket, etc. After the shipper's item is delivered, don't forget to leave feedback for the driver on the My uShip page.”

In the event that the driver declines, the following is received:
“The driver, user ID, has declined the shipper's shipment. Drivers have many reasons for declining shipment including: insufficient compensation, too far out of their way, item won't fit in their vehicle, or insufficient shipper feedback. If all of the drivers that the shipper selected have declined, please return to the shipper's my uShip page to select additional drivers. If no additional drivers are listed, the shipper's shipment is saved and the shipper will be notified when a driver selects the shipper's shipment. The shipper can always change the shipper's shipment details or delete the shipment on the shipper's my uShip page.”

If the driver has replied with a binding counter-offer, the shipper can accept or decline the counter-offer amount. The driver is sent an e-mail detailing the counter-offer response.

In the present embodiment, the system allows a driver to select one item at a time. Driving directions will be provided from start to pick-up to drop-off to destination only. After selecting one item, the driver can choose to return to the list and select another item. Alternative embodiments may allow drives to check boxes next to multiple items and receive a route for pick-up and drop-off of each of the items for which the driver is approved by the shipper.

The present invention also provides a quick search for shipments along the shipper's route now and the fields: starting address, ending address [or just zips]. Any user (including non-members) can check a trip using just these two fields. After a user presses submit, the system searches for shipments currently saved along this route, ignoring all other trip details. The resulting list is limited only by distance out of the way with a cutoff of [100 miles or 25% of the trip length]. If no items are available: “There are currently no shipments along that route.

FIGS. 23 through 25 provide one embodiment of the route deviation search form of the present embodiment of the invention. After logging in, the registered driver is taken to the full trip form with the starting and ending addresses already filled in. The driver fills in the following fields listed therein. This is submitted in steps in order to geocode addresses and calculate straight line possibilities.

After submit the route deviation form, the driver is presented a list of shipments that meet his criteria. The system initially limits the universe of shipments by calculating the straight line distances using latitude and longitude for the locations. Any shipment for which the distance from the drivers starting address to the pick-up address is more than the driver's baseline trip distance plus the his maximum route deviation is eliminated from consideration. Additionally, if the distance from shipment pick-up to drop-off is greater than the driver's baseline trip plus the driver's maximum route deviation, the item is eliminated from consideration. For each matching item, the compensation amount, out-of-way, title, description, dimensions, weight, and shipper ID/feedback are shown, along with a button for details. If the driver presses the details button, all of the item information is provided.

The matching shipments are initially sorted by route deviation, but can be sorted by any of the columns by clicking on the column name. Each shipment has a details button to see all of the trip details. On this details page, the driver can post a question about the shipment. The shipper is sent an email notifying them of a question and they can post a response. “Select one [or more] of the items below. Make sure that the item will fit in the shipper's vehicle before the shipper select it. Remember, the shipper's selection of an item represents a binding contract between the shipper and the shipper. With the present embodiment, the driver only selects multiple items if the shipper is willing and able to transport ALL of them in the driver's vehicle at once. It is usually better to select one item at a time and wait to be approved or declined by the shipper before selecting additional items.

When the shipper press SELECT, an e-mail will be sent to the shipper[s]. The shipper must approve the shipper as a driver before the match is complete. The shipper will be notified when the shipper approves or declines the shipper's trip. The shipper will only be charged a transaction fee if the shipper is approved by the shipper and a match is completed.” After selecting an item, the following page brings up the return trip matches if return box checked: “The following items are available for the shipper's return trip. Please select one . . . same as above” Shipper Approval/Denial occurs when a driver is sent an e-mail when the shipper approves him. As always, the shipper can manage the shipper's saved, pending, committed, and completed trips on the My uShip page. The shipper may close this trip so that the shipper do not receive additional shipment notifications on the My uShip page.

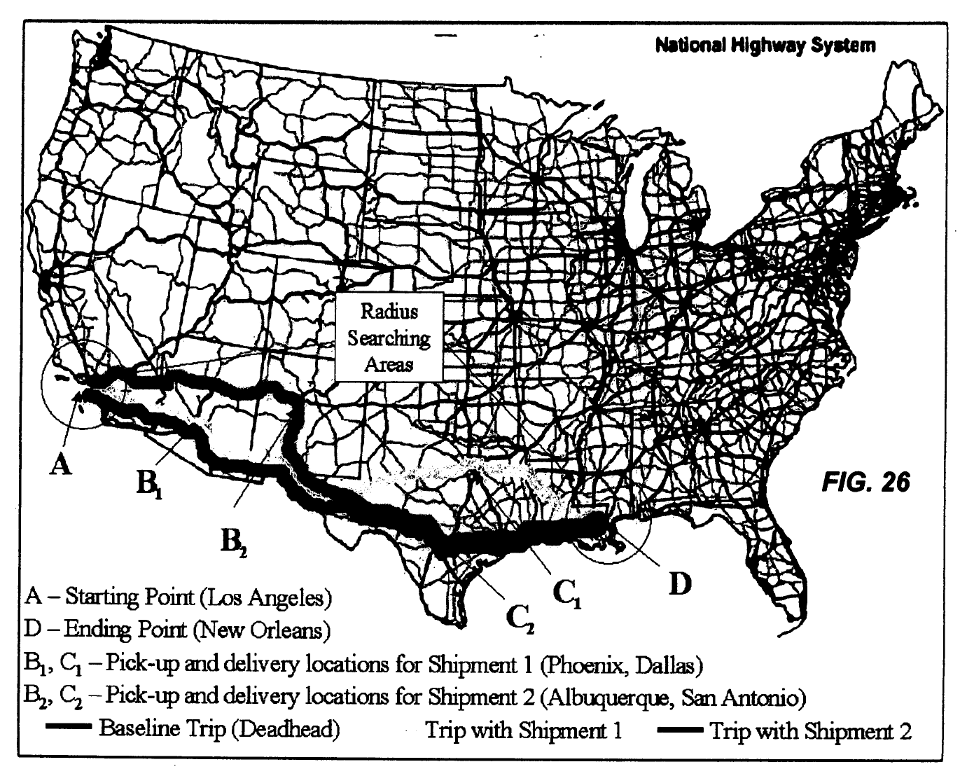

An integral aspect of the present embodiment includes a novel load matching system for the peer-to-peer shipment delivery method and system. FIG. 26 shows a map of the US highway system. A carrier submits a trip listing, which includes the starting and ending locations (usually addresses) A and D. The system will, by default, calculate the driving distance for the shortest possible route to serve as a baseline. Alternatively, the carrier can choose for the system to use driving time as the route deviation parameter or the carrier can specify his baseline route if it is different than the assumed (shortest) route. For a commercial trucker, this trip might represent a “deadhead” leg for which the trucker has no load but must take anyway. For an individual (non-commercial) driver, this trip might be a road trip to visit family or friends. The system calculates the driving distance (or time) from the carrier's starting point A to shipment pick-up locations (B₁, B₂, B₃, . . . , BB) that are saved in the shipment database. The system has previously calculated (when submitted by the shipper) the driving distance (or straight line) from each shipment's pick-up location to its delivery location (B₁C₁, B₂C₂, B₃C₃, etc.). The system calculates the driving distance from each shipment's delivery location (C₁, C₂, C₃, etc.) to the carrier's trip ending location (D). The system totals the driving distances ABₙCₙD for all n shipments in the system. The system subtracts the driving distance of the baseline trip AD from ABₙCₙD for all n shipments to yield the route deviation (extra driving distance) for all n shipments. The carrier is presented a list of shipments that have been sorted based on route deviation up to the carrier's (or the system's) pre-defined maximum deviation. A similar process is followed when a shipper submits a shipment listing (B, C). The distance AₙBCDₙ is calculated for all n trips in the trip database. Each carrier's baseline trip distance AₙDₙ is subtracted from AₙBCDₙ to yield a route deviation for each trip listing. The shipper is presented a list of carriers whose route deviation is below the carriers' (or the system's) pre-defined maximum. This list can be sorted by route deviation, trip dates, or any other parameter of the trips.

This method of searching based on route deviation distance is far superior to known search methods. A key benefit of route deviation searching is that every possible shipment origination and destination location along the carrier's route is checked with just one search. Rather than the guessing game of known processes, carriers and shippers are able to find relevant results after performing a single search. Even after multiple search attempts, none of the currently used search methods successfully match the carrier with only those shipments that are along his route (Shipment 1 or Shipment 2 in the FIGURE). Additionally, route deviation searching automatically provides the carrier with accurate driving distance calculations rather than vague radius areas to make his shipment selection decision much easier.

Finally, route deviation searches allow the carrier to obtain all the relevant information about potential shipments (and vice versa) without the system having to divulge the addresses and contact information of the shippers. By showing carriers only the route deviation distance or time in their search results, the shipper's contact information and locations can be withheld until after a match has been made and confirmed. This makes it is possible for a load matching system to operate on a transaction fee basis, rather than the predominant subscription model.

Carriers and shippers prefer free searches with a transaction fee to subscription-based, paid-search models. If addresses and contact information are shown during a search, then the parties can bypass the system to arrange a transaction. This is the primary reason that current load matching systems must charge a subscription fee for access to searches. Route deviation search technology provides carriers and shippers with enough information to make a decision without divulging addresses and other contact information.

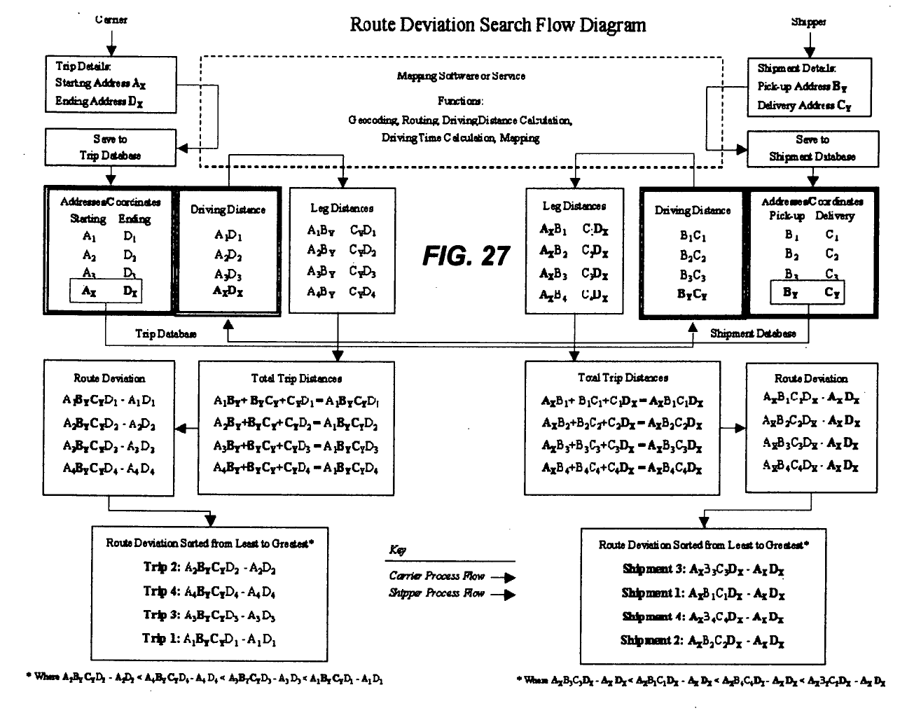

The search process of the present invention, from the carrier perspective, appears in FIG. 27, and operates as follows: When a carrier enters a new trip listing into our system, the route deviation search process begins. First, the system calculates the driving distance of the carrier's baseline trip—from starting address (A_{X}) to ending address (D_{X}) using standard, widely available route optimization and street mapping software or services. All routes are assumed to be either the shortest distance or the shortest travel time. The carrier's starting and ending addresses are then compared to each shipment listing in the database.

The system calculates the driving distance from A_{X} to each shipment's pick-up address (B₁, B₂, B₃, etc.), and from each shipment's delivery address (C₁, C₂, C₃, etc.) to D_{X}. Then, the system calculates the total trip distance that the carrier would take from his starting address (A_{X}), to each shipment's pick-up address (B₁, B₂, B₃, etc.), to each shipment's delivery address (C₁, C₂, C₃, etc.), and finally to his ending address (D_{X}). Each shipment listing therefore has an additional property, distance A_{X}B₁C₁D_{X} (for shipment number 1), which is relevant only to this particular carrier's search.

The carrier's baseline trip distance A_{X}D_{X} is subtracted from each shipment listing's total distance (A_{X}BCD_{X}), resulting in an “out-of-way” distance, or route deviation, for each package in the system. Finally, all shipments in the system are sorted by route deviation distances, from least to greatest, and displayed as the search result to the carrier up to the carrier's pre-defined, maximum cut-off for route deviation distance.

Other manifestation of the invention may include, for example, (1) using straight line distance instead of driving distance to calculate route deviation; (2) using driving time to measure route deviation rather than driving distance; (3) using Lat/Long coordinates as locations rather than addresses; (4) using route deviation to search for things other than shipments (e.g. taxis matched with people); and (5) single route deviation searches for ocean or air freight matching.

Although, the method above may be computationally intensive for calculating driving distances (A_{X}BCD_{X}) for each shipment in the system, a number of techniques exist to initially limit the universe of shipments. The system may calculate the straight-line (rather than driving) distances using the latitude and longitude coordinated of each address or location (obtained by geocoding process). Any shipment for which the distance from the carrier's starting address (A_{X}) to the pick-up address (B) is more than the driver's baseline trip distance (A_{X}D_{X}) plus his maximum route deviation (driver specified) is eliminated from consideration. Additionally, if the distance from shipment pick-up (B) to delivery (C) is greater than the driver's baseline trip (A_{X}D_{X}) plus his maximum route deviation, the item is eliminated from consideration.

The resulting shipment listings are initially sorted by route deviation distance, but the carrier can choose to further sort the results by other shipment properties including compensation amount, title, description, dimensions, weight, and shipper ID/feedback by clicking on the column name. The carrier may view the full shipment listing by clicking on the title of the shipment.

The search process may occur, from the shipper's perspective, also appears in FIG. 27, as follows: After the shipper submits the shipment's details, the system saves the shipment listing and checks the trip database for carrier trips that are along the route of the shipment within the allowable route deviation. First, the system calculates the driving distance of the shipment's delivery route—from pick-up address (B_{Y}) to delivery address (C_{Y}) using standard, widely available route optimization and street mapping software or services.

All routes are assumed to be either the shortest distance or the shortest travel time. The shipment's pick-up and delivery addresses are then compared to each trip listing in the database. The system calculates the driving distance from each trip's starting address (A₁, A₂, A₃, etc.) to the shipment's pick-up address (B_{Y}), and from the shipment's delivery address (C_{Y}) to each trip's ending address (D₁, D₂, D₃, etc.). Then, the system calculates the total trip distance that each carrier would take from his starting address (A₁, A₂, A₃, etc.) to the shipment's pick-up address (B_{Y}), to the shipment's delivery address (C_{Y}), and finally to each trip's ending address (D₁, D₂, D₃, etc.).

Each trip listing therefore has an additional property, distance A₁B_{Y}C_{Y}D₁ (for trip number 1), which is relevant only to this particular shipper's search. Each carrier's baseline trip distance (A₁D₁, A₂D₂, A₃D₃, etc.) is subtracted from each trip's total distance (AB_{Y}C_{Y}D), resulting in an “out-of-way” distance, or route deviation, for each trip in the system. Finally, all trips in the system are sorted by route deviation distances, from least to greatest. Those trips for which the route deviation is less than or equal to the driver's pre-defined, maximum cut-off for route deviation distance are displayed as the search result to the shipper.

The method described above may be computationally intensive for calculating driving distances (AB_{Y}C_{Y}D) for each trip in the system, however, a number of techniques exist to initially limit the universe of shipments. The system may, for example, calculate the straight-line (rather than driving) distances using the latitude and longitude coordinated of each address or location (obtained by geocoding process). Any trip for which the distance from the carrier's starting address (A) to the pick-up address (B_{Y}) is more than the driver's baseline trip distance (AD) plus his maximum route deviation (driver specified) is eliminated from consideration. Additionally, if the distance from shipment pick-up (B_{Y}) to delivery (C_{Y}) is greater than the driver's baseline trip (AD) plus his maximum route deviation, the trip is eliminated from consideration.

Although the discussion, thus far, has been limited to the instance of automobile driving, the invention should not be so limited. As those skilled in the art will appreciate, this invention can also be applied to air travel, sea travel, or other forms of vehicular travel, among other things. It will be understood, therefore, that the invention may be embodied in other specific forms without departing from the spirit or central characteristics thereof. The present examples and embodiments, therefore, are to be considered in all respects as illustrative and not restrictive, and the invention is not intended to be limited to the details given herein. Preferred embodiments of this method and system are described herein, including the best mode known to the inventor for carrying out the method and system.

What is claimed is:

1. A method for facilitating peer-to-peer shipment of goods outside of traditional shipping industry channels, comprising the steps of:
listing at least one non-commercial shipment in a non-commercial shipment data set through a shipment listing template according to a predetermined set of parameters, said shipment listing template permitting direct listing of said non-commercial shipment by an individual user for delivering said non-commercial shipment to a predetermined destination;
listing at least one non-commercial trip in a non-commercial trip data set through a trip listing template according to a predetermined set of parameters, said trip listing template permitting direct listing of said non-commercial trip by a non-commercial traveler;
determining a necessary route deviation from said non-commercial trip for delivering said non-commercial shipment to said predetermined destination using a set of route deviation instructions;
associating said non-commercial shipment data set with said non-commercial trip data set using a set of matching instructions, said matching instructions for facilitating an optimal matching of said at least one non-commercial shipment to one of said at least one non-commercial trips, said matching instructions associating further with said route deviation instructions;
facilitating a transaction between said individual user and said non-commercial traveler using a set transaction instructions for delivering said non-commercial shipment to said predetermined destination consistent with said optimal matching from said matching instructions.

2. The method of claim 1, further comprising the step of providing an online interface to said individual user for matching said at least one non-commercial parcel to said at least one non-commercial trip using a set of matching instructions, wherein said matching instructions further evaluate whether said non-commercial traveler travels in a vehicle having a minimum set of functional characteristics for shipping said non-commercial parcel.

3. The method of claim 1, further comprising the step of filtering shipments for listing only those shipments for which the compensation is high relative.

4. The method of claim 1, further comprising the step of automatically identifying heavier shipment listings that may automatically require for necessary equipment for matching trip listings.

5. The method of claim 1, further comprising the step permitting a counterparties in a shipping transactions to record feedback relating to a shipping transaction, from the group consisting essentially of positive, neutral, negative classification, and notations feedback.

6. The method of claim 1, further comprising the step of preventing member addresses and contact information from being divulged to counterparties until the mutual acceptance process is complete.

7. The method of claim 1, further comprising the step of a providing return trip listing is automatically generated, saved, and run to show the carrier shipments along the return route.

8. The method of claim 1, further comprising the step of filtering and sorting trip lisitngs by route deviation and automatic cut-offs.

9. The method of claim 1, further comprising the step of saving a trip listing with no trip dates when anything along a specified route is listed that meets the above criteria.

10. The method of claim 1, further comprising the step of permitting a carrier to chose a minimum compensation that is required to pick-up and drop-off any shipments during your trip.

11. The method of claim 1, further comprising the step of, upon accepting the price set by the shipper, permitting a carrier to make a binding counter offer that will be sent to the shipper.

12. The method of claim 1, further comprising the step of, upon accepting a matching trip or shipment, permitting a counterparty to review a member's feedback and listing details.

13. The method of claim 1, further comprising the step of permitting a first carrier to accept a response from a shipper will create a match, if more than one carrier is selected by the shipper.

14. The method of claim 1, further comprising the step of notifying a member when a new shipments is listed that meet certain search criteria.

15. The method of claim 1, further comprising the step of allowing trip listings to expire after a predetermined duration.

16. The method of claim 1, further comprising the step of permitting a shippers to choose a listing expiration date for their shipment listing, after which time the shipment will be removed from our active shipments database.

17. The method of claim 1, further comprising the step of permitting a carriers to choose to sort or filter their search results by date of shipment listing expiration.

18. The method of claim 1, further comprising the step of scheduling a carrier acceptance of shipments to expire after a specified duration.

19. The method of claim 1, further comprising the step of, upon accepting a shipment, permitting a carrier to choose to submit offered pick-up and delivery dates.

20. The method of claim 1, further comprising the step of, upon a carrier accepting a shipment, permitting said carrier to choose to submit offered pick-up and delivery dates, which dates may be automatically included in their trip listing visible to the shipper.

21. The method of claim 1, further comprising the step of a providing a question and answer system for allowing shippers and drivers to communicate via their shipment/trip listing pages.

22. The method of claim 1, further comprising the step of allowing carriers and shippers to save listings for easy retrieval without running the searches again.

23. The method of claim 1, further comprising the step of posing a “ship now” offer price for a shipment listing.

24. The method of claim 1, further comprising the step of permitting a shipper to choose to automatically accept any driver that accepts their item.

25. The method of claim 1, further comprising the step of allowing a shipper to upload a digital photo of a shipment.

26. The method of claim 1, further comprising the step of permitting a carriers to sort or filter search results by availability of shipment photographs.

27. The method of claim 1, further comprising the step of permitting a carrier to upload a digital photo of their vehicle.

28. The method of claim 1, further comprising the step of permitting a shipper to sort or filter their search results by availability of carrier photographs.

29. The method of claim 1, further comprising the step of permitting a member to choose to browse through our database of completed shipment transactions.

30. The method of claim 1, further comprising the step of permitting the searching of shipment and trip listings by keyword.

31. The method of claim 1, further comprising the step of permitting a carrier to specify a route to use as their baseline route for route deviation calculations.

32. The method of claim 1, further comprising the step of permitting searching results to be sorted or filtered by the shipment or trip listing containing any of the aforementioned special requirements.

33. The method of claim 1, further comprising the step of presenting a shipment listing page containing a map showing the carriers baseline route and a new route including the pick-up and delivery stops.

34. The method of claim 1, further comprising the step of permitting a carrier to sort or filter their search results by the shipment type.

35. A method for associating a parcel listing with a baseline trip listing for delivering a parcel to a predetermined destination, comprising the steps of:
submitting a baseline trip listing into a data set of baseline trip listings, said baseline trip listing representing a baseline trip of a traveler;
submitting a parcel listing into a data set of parcel listing, said parcel listing representing an order for delivering a parcel to a predetermined destination;
matching said trip listing with said parcel listing according to a route deviation determination, said route deviation representing the required deviation from said baseline trip for delivering said parcel to said predetermined destination.

36. A method for performing a route deviation search, comprising the steps of:
storing a trip listing of a carrier into a trip listing data set, said trip listing comprising a starting location (A) and an ending location (D);
calculating a baseline parameter (AD) associated with a baseline route between said starting location (A) and said ending location (D);
storing a plurality of shipment listings in a shipment listing data set, each of said plurality of shipment listings representing a shipment from a pick-up location to a delivery location and comprising an associated shipment pick-up location (B₁, B₂, . . . , Bₙ) and an associated shipment delivery locations (C₁, C₂, . . . Cₙ);
calculating a first set of carrier parameters (AB₁, AB₂, . . . , ABₙ)from said starting location (A) to each of said associated shipment pick-up locations (B₁, B₂, . . . Bₙ);
calculating a plurality of shipment transportation parameters (B₁C₁, B₂C₂, . . . , BₙCₙ) from said associated shipment pick-up locations (B₁, B₂, . . . , Bₙ) to an associated shipment delivery locations (C₁, C₂, . . . , Cₙ);
calculating a second set of carrier parameters (C₁D, C₂D, . . . , CₙD) from said associated shipment delivery locations to said ending location;
calculating a set of total modified route parameters (AB₁C_{1D}, AB₂C₂D, . . . , ABₙCₙD) comprising a total route from said starting location (A) through each of said associated shipment pick-up locations (B₁, B₂, . . . , Bₙ) and said associated shipment delivery locations (C₁, C₂, . . . , Cₙ) to said ending location (D);
subtracting from each of said set of total modified route parameters said baseline parameter (AD) for all shipment listings in said shipment listing data set for yielding a route deviation for all shipments in said shipment listing data set;
presenting to said carrier a list of shipments and associated route deviations, said list of shipments from which said carrier may select a shipment for delivering at least one of said shipments from said set of shipment listings.

37. The method of claim 36, further comprising the step of sorting said shipment listing according to one of the group consisting essentially of route deviation, trip dates, or other trip parameter of the trip.

38. The method of claim 36, wherein said carrier parameters further comprise a first set of travel times (AB₁, AB₂, . . . , ABₙ) from said starting location (A) to each of said associated shipment pick-up locations (B₁, B₂, . . . , Bₙ).

39. The method of claim 36, wherein said baseline route further comprises a deadhead leg for said carrier on which said carrier is planning to carrier no other load.
